(19) United States
(12) Patent Application Publication
(10) Pub. No.: US 2025/0309320 A1
(43) Pub. Date: Oct. 2, 2025

(54) INSPECTION DURING THE MANUFACTURE OF MODULES OR PRELIMINARY STAGES OF MODULES

(71) Applicant: MB Automation GmbH & Co. KG, Roding (DE)

(72) Inventors: Ondrej Vasko, Schwandorf (DE); Jessica Mayer, Dieterskirchen (DE)

(21) Appl. No.: 18/862,981

(22) PCT Filed: Apr. 25, 2023
(86) PCT No.: PCT/EP2023/060731

§ 371 Date: Nov. 5, 2024

(30) Foreign Application Priority Data
May 12, 2022 (DE) 102022111903.3

(51) Int. Cl. H01M 10/04; G01B 11/00; G01B 11/27

(52) U.S. Cl. CPC H01M 10/0404; G01B 11/005; G01B 11/272

(57) ABSTRACT

An inspection in the manufacture of modules or pre-stages of modules, comprising providing a separated anode/cathode layer at a pick-up location; conveying a stacking apparatus to the pick-up location; picking up the anode/cathode layer from the pick-up location by the stacking apparatus; detecting the position and/or orientation of the anode/cathode layer; transporting the anode/cathode layer to a stacking location by the stacking apparatus; aligning the stacking apparatus with the transported anode/cathode layer relative to the stacking location; and stacking the transported anode/cathode layer at the stacking location.

### CROSS-REFERENCE TO RELATED APPLICATIONS

This application is a National Stage application of International Application No. PCT/EP2023/060731 filed Apr. 25, 2023, which claims priority to German Patent Application Serial No. DE 102022111903.3 filed May 12, 2022.

### BACKGROUND

### Field

An inspection during the production of modules or preliminary stages of modules is disclosed herein. These modules or their preliminary stages can be, for example, layer arrangements containing layer material, arrangements for fuel or battery cells, or parts for their production. This inspection is disclosed as a method and as an apparatus. Details are defined in the claims. The description also contains relevant information on the structure and function of the inspection as well as on apparatus and process variants.

### Discussion of the Related Art

WO 2021 171 946 A1 relates to a testing apparatus for testing the position of the electrode layer in a laminate, in which a release film and an electrode layer are bonded by an adhesive, from the release film side. An infrared irradiation unit irradiates the laminate with infrared light from the release film side. A camera sensitive to infrared light records the infrared light transmitted through the release film and reflected by the electrode layer. A detection unit records the position of the electrode layer based on the image captured by the camera. Stacks of laminate consisting of release films and electrode layer are stacked on a stacking table. A transport unit is used to transport the release films and electrode layer and to place them on the stacking table. The testing apparatus checks the position of the electrode layer in the laminate stack released by the transport unit.

KR 10 23 70 748 B1 relates to an electrode layer loading apparatus for a secondary battery. The apparatus has an electrode layer pick-up unit for picking up electrode layers, which are stacked and fed individually to a magazine unit. A visual inspection unit detects the alignment status of the electrode layer by directing a plurality of cameras at the electrode position of the electrode layers. A loading driver is used to place the electrode layer on the stacking table by moving the electrode plate near me unit to a position on the stacking table.

In other known solutions, the finished battery cell, and in preliminary stages the electro den stacks, are tested for electrical short circuits. This procedure leads to a high proportion of unusable (intermediate and final) products, as even non-precisely manufactured electrode stacks are laminated and then finally processed into an inadequate battery cell.

Based on this, an arrangement and a procedure are to be provided which allow to produce with high processing speed modules or preliminary stages of modules, for example fuel or battery cells containing layer material, with high precision, reduce their short-circuit risk and improve their efficiency.

### SUMMARY

An inspection method in the manufacture of modules or preliminary stages of modules at comprises the steps, for example in the following sequence: providing a separated anode and/or cathode layer at a pick-up location; conveying a stacking apparatus to the pick-up location; picking up the anode/cathode layer from the pick-up location by the stacking apparatus; detecting the position and/or orientation of the anode/cathode layer; transporting the anode/cathode layer to a stacking location by the stacking apparatus; aligning the stacking apparatus with the transported anode/cathode layer relative to the stacking location; and stacking the transported anode/cathode layer at the stacking location.

In variants of the inspection method, individual anode layers are alternately transported to the stacking location from a first side using a first stacking apparatus, and individual cathode layers are transported to the stacking location from an opposite second side using a second stacking apparatus. In variants of the inspection method, individual anode layers are alternately transported to the stacking location exclusively from the first side using a first stacking apparatus, and individual cathode layers are transported to the stacking location exclusively from the opposite second side using a second stacking apparatus. These procedures are advantageous because they ensure that the sensitive electrodes are handled by the stacking apparatus without any contamination of the electrode coatings on the contact surfaces of the stacking apparatus.

In variants of the inspection method, the position and/or orientation of the anode/cathode layer is recorded before the anode/cathode layer is picked up by the stacking apparatus from the pick-up location and/or during the transport of the anode/cathode layer by the stacking apparatus to the stacking location. In variants of the inspection method, the position and/or orientation of the anode/cathode layer is detected during transportation of the anode/cathode layer by the stacking apparatus to the stacking location by means of a first camera and/or before the anode/cathode layer is picked up by the stacking apparatus from the pick-up location by means of a second camera.

To ensure exact positioning, in one variant a preliminary position on the transport of the incoming anode/cathode layers is first checked with the aid of a matrix camera and an illumination apparatus (white, adjustable 0-20°).

In variants of the inspection method, the first and/or the second camera detect the position and/or orientation of the anode/cathode layer in a vertical, ±approximately 25°, top view of the anode/cathode layer. In variants of the inspection method, a white light source assigned to the first and/or second camera illuminates the anode/cathode position for image capture by the first and/or second camera. In variants of the inspection method, the first and/or the second camera completely capture the anode/cathode position with a (single) image capture in order to detect its position and/or orientation. In variants of the inspection method, the first and/or the second camera capture a region, at least one corner region, two diagonal corner regions, and/or at least one corner region and at least a section of an edge of the anode/cathode layer with a single image feed in order to detect the position and/or orientation of the anode/cathode layer. In variants of the inspection method, the first and/or the second cameras are designed as line scan cameras, which detect the position and/or orientation of the anode/cathode layer before it is picked up by the stacking apparatus or when it arrives at the pick-up location or on the way to the pick-up location.

In variants of the inspection method, at least one optically effective element is connected upstream of the first and/or second camera in order to detect the position and/or orientation of the anode/cathode layer at one or more points or regions before it is picked up by the stacking apparatus or when it arrives at the pick-up location or on the way to the pick-up location.

In variants of the inspection method, correction values are determined from the position and/or orientation of the anode/cathode layer before it is picked up by the stacking apparatus, the position and/or orientation of the stacking apparatus, and/or the position and/or orientation of the picked-up individual anode/cathode layer during a transport of the anode/cathode layer to the stacking location. In variants of the inspection method, these correction values are taken into account when aligning the stacking apparatus with the transported anode/cathode layer relative to the stacking location. In variants of the inspection method, these correction values are taken into account when aligning the stacking apparatus for picking up the anode/cathode layer by the stacking apparatus in such a way that the anode/cathode layer is picked up in a central zero position and/or aligned by the stacking apparatus.

In one variant of the inspection method, the calculated correction values can be used to position the stacking apparatus relative to the anode/cathode layer before/when it is picked up in such a way that the anode/cathode layer is picked up by the stacking apparatus in a zero position. For this purpose, the stacking apparatus can be corrected in its position and/or orientation relative to the anode/cathode position at the pick-up location.

Similarly, after being picked up during transportation, the stacking apparatus can be positioned according to the correction values from the image feed so that the anode/cathode layer is deposited by the stacking apparatus at the stacking location on the electrode stack located there in such a way that the anode/cathode layer is deposited appropriately and with minimal or no further correction movement.

This method can be carried out very quickly and with high precision. An apparatus described below, for example, is suitable for carrying out this method.

An apparatus for conveying and inspecting modules or precursors of modules comprises: a stacking apparatus, intended and set up for picking up a combined anode/cathode layer at a pick-up location; a conveying apparatus, intended and set up for conveying the stacking apparatus towards the pick-up location and away from the pick-up location; a first camera, intended and set up for detecting the position and/or orientation of the anode/cathode layer on its path from the pick-up location to the stacking location; an actuating apparatus, comprising at least one actuator, intended and set up for actuating the stacking apparatus for picking up the anode/cathode layer, and/or for aligning the stacking apparatus with the anode/cathode layer relative to the stacking location during transportation of the anode/cathode layer to the stacking location, and/or for stacking the anode/cathode layer at the stacking location.

In variants of the apparatus, a first stacking apparatus is provided and set up for transporting individual anode layers from a first side, and a second stacking apparatus is provided and set up for transporting individual cathode layers to the stacking location alternately with the first stacking apparatus from an opposite second side. In variants of the apparatus, the first stacking apparatus transports individual anode layers to the stacking location exclusively from the first side, and the second stacking apparatus transports individual cathode layers to the stacking location exclusively from the opposite second side.

In variants of the apparatus, a first camera is intended and set up for detecting the position and/or orientation of the anode/cathode layer during transportation of the anode/cathode layer by the stacking apparatus to the stacking location. In variants of the apparatus, a second camera is intended and set up for detecting the position and/or orientation of the anode/cathode layer before the anode/cathode layer is picked up from the pick-up location by the stacking apparatus.

In variants of the apparatus, the first and/or the second camera are intended and set up for detecting the position and/or orientation of the anode/cathode position in a vertical, ±approximately 25°, top view of the anode/cathode position. In variants of the apparatus, a white light source assigned to the first and/or the second camera is intended and set up for detecting the anode/cathode position for an image capture by the first and/or second camera. In variants of the apparatus, the first and/or the second camera are intended and set up for detecting the anode/cathode position fully continuously with a (single) image capture in order to detect its position and/or orientation. In variants of the apparatus, the first and/or the second camera are intended and set up for detecting a region, at least one corner region, two diagonal corner regions, and/or at least one corner region and at least a section of an edge of the anode/cathode layer with a single image feed, in order to detect the position and/or orientation of the anode/cathode layer. In variants of the apparatus, the first and/or the second camera are designed as a line scan camera, which are intended and set up for detecting the position and/or orientation of the anode/cathode layer before it is picked up by the stacking apparatus or when it arrives at the pick-up location or on the way to the pick-up location.

In variants of the apparatus, at least one optically active element is connected upstream of the first and/or second camera and is intended and set up for detecting the position and/or orientation of the anode/cathode layer at one or more points or regions before it is picked up by the stacking apparatus or when it arrives at the pick-up location or on the way to the pick-up location. In variants of the apparatus the at least one optically active element is a lens or lens arrangement, a mirror or a mirror arrangement, a prism or a prism arrangement, a region light, a coaxial ring light, a dark-field light, or combinations thereof.

In variants of the apparatus, a control unit is intended and set up for determining correction values from the image feed and/or data from the acquisition apparatus and/or the first and/or the second camera from the position and/or orientation of the anode/cathode layer before it is picked up by a stacking apparatus, the position and/or orientation of the stacking apparatus, and/or the position and/or orientation of the individual anode/cathode layer picked up on relative to the stacking apparatus during a transport of the anode/cathode layer to the stacking location. In variants of the apparatus, the control unit is intended and set up for taking these correction values into account in positioning commands to the positioning apparatus, the conveyor apparatus and/or the stacking apparatus when aligning the stacking apparatus with the transported anode/cathode layer relative to the stacking location.

In variants of the apparatus, a control unit is intended and set up for taking into account these correction values for the alignment and the location of the stacking apparatus when picking up the anode/cathode layer in positioning commands to the positioning apparatus, the conveying apparatus and/or the stacking apparatus in such a way that the stacking apparatus picks up the respective anode/cathode layer in a central zero position and/or aligned with the electrode stack located at the stacking location.

By checking the position of the incoming anode/cathode layer before or in the pick-up location, the alignment and location of the stacking apparatus can be precisely determined during or before the anode/cathode layer is picked up. This allows the anode/cathode layer to be picked up by the stacking apparatus in a precisely coordinated and controlled manner. In one variant, a further check of the alignment and location of the lifted individual anode/cathode layer takes place during the conveying of the stacking apparatus into the stacking location, which additionally increases the precision of the placement of the individual anode/cathode layer on the stack of electrodes at the stacking location.

A further inspection method in the manufacture of modules or preliminary stages of modules comprises the steps, for example in the following sequence: Providing a combined anode/cathode layer; Transporting the anode/cathode layer to a stacking station by a stacking apparatus; Stacking the transported anode/cathode layer at the stacking station; Detecting a stack of electrodes grown around the stacked anode/cathode layer at the stacking location in at least one side view and/or a high edge of the stack of electrodes at the stacking location; and Checking the orientation and/or position of the or each stacked anode/cathode layer relative to the remaining stack of electrodes grown at the stacking location.

This procedure allows the exact position of the top layer to be determined in relation to the other layers of the electrode stack. This check becomes increasingly important as the height of the electrode stack increases, as an incorrectly positioned top layer must lead to the electrode stack being discarded without further correction. However, the inspection becomes increasingly accurate as the height of the electrode stack increases, as the geometric regions to be measured (corner or high edge of the electrode stack pile) can be detected and evaluated more easily and precisely.

In one variant of the method, this also allows more precise correction values to be calculated when the next layer is placed on the electrode stack. Overall, this method with the precise position check allows a considerable reduction in the risk of short circuits, for example in the fuel or battery cells.

This is also made clear by the fact that previous solutions only deposit the layers with an accuracy of ±0.5 mm, whereas the solution presented here allows an accuracy of ±0.1 mm and more when depositing the anode/cathode layers on the electrode stack in order to reduce waste and improve efficiency.

After placing the anode/cathode layers on the electrode stack, the position/offset of the individual layers in relation to each other is checked and, as a result, whether/with what deviation in the longitudinal or transverse direction the individual layers of the entire electrode stack are aligned with each other. In one variant, an offset of the individual layers relative to each other is determined with a (single) image capture by at least one third camera of at least one (vertical and/or transverse) edge of the electrode stack (grown up to the current image capture). By analyzing the image capture obtained using image processing at means (corner/edge search, etc.), it is possible to check whether one or more layers of the electrode stack are protruding or not protruding in the longitudinal or transverse direction relative to the other layers, and whether a pre-specified accuracy has been maintained when stacking the anode/cathode layers in relation to one another. The alternately stacked anode layers and cathode layers of the electrode stack have different dimensions from each other, resulting in a stepped (raised) edge in the side view, which must be processed (image) accordingly. It may be relevant with which deviation from the usual dimensions of the anode or cathode layers each individual layer protrudes (laterally). It may also be relevant that the different anode/cathode layers always form equally high steps in the entire electrode stack. The latter is evidence that the individual anode/cathode layers were stacked without folds or creases.

For this purpose, in one variant of the method, alternately stacked anode layers and cathode layers of the electrode stack, which have different dimensions with a (high) edge stepped in the z-direction in the side view, are examined for their shape and/or dimensions. In one variant of the method, alternately stacked anode layers and cathode layers of the electrode stack are examined, with which deviation compared to the remaining anode or cathode layers of the electrode stack each individual layer (laterally) protrudes inwardly/outwardly. In a variant of the method, the deviation in the z-direction (vertical axis) with which the various anode/cathode layers form steps in the electrode stack is determined.

In one variant of the method, two third matrix cameras are used, which (viewed from above) are directed at diagonally opposite corners/(vertical) edges of the electrode stack at the deposit point. In one variant of the method, the cameras are set to the respective edge of the electrode den stack. In one variant of the procedure, (white) spot lights are used to illuminate the respective edge of the electrode stack, which illuminate the desired position.

In one variant of the method, four third matrix cameras are used, which (viewed from above) are directed at all four corners/(vertical) edges of the electrode stack at the deposit site. In one variant of the method, backlighting or darkfield illumination is achieved by means of respective light sources. This allows the relevant regions of the various anode/cathode layers to be easily recognized in transmitted light. In one variant of the method, mirrors or prisms are used to guide the beam path of the third cameras for adaptation to spatial conditions.

In one variant of the method, a third matrix camera is used with a view field of view of the electrode stack from above, which captures the electrode stack as a whole completely in one image feed, or two third matrix cameras, each of which captures one of two diagonal corners of the electrode stack from above, up to four third matrix cameras, which capture all four corners of the electrode stack from above and which are directed in the top view onto the electrode stack at the deposit point. Here too, in one variant, the beam path of the cameras is guided by appropriate arrangements of mirrors or prisms for adaptation to spatial conditions. In one variant, a coaxial (red) light and a (white) spotlight are used for the lighting for each of the third cameras.

This makes it possible to recognize very precisely that the anode/cathode layers are always placed in the correct position on the electrode stack.

In a variant of the method, the movements of the lifting apparatus with the respective workpiece carrier along the vertical axis (z-axis) and their inaccuracies are also taken into account by using the third cameras to record the x, y positions of the workpiece carrier at different z heights before the start of depositing the anode/cathode layers to form the electrode stack. In this way, the third cameras can be used to check whether the anode/cathode layers have been stacked at the correct x, y position, which corresponds to the respective z position of the workpiece carrier on the lifting apparatus, while the anode/cathode layers are being le stacked. The accuracy in the direction of rotation around the vertical axis (in theta) when picking up the anode/cathode layers with the stacking apparatus can also be corrected in this way for subsequent precise stacking of the anode/cathode layers of the electrode stack.

An apparatus for conveying and inspecting modules or preliminary stages of modules is equipped with a pick-up location for providing a separated anode/cathode layer; a stacking apparatus, intended and set up for transporting the anode/cathode layer to a stacking location; for stacking the transported anode/cathode layer at the stacking location; a camera, intended and set up for capturing an image feed of an electrode stack grown around the stacked anode/cathode layer at the stacking location in at least one side view and/or including a high edge in the z-direction of the electrode stack at the stacking location; and a control unit, intended and set up for determining from the image feed of the second camera the orientation and/or position of the or each stacked anode/cathode layer relative to the rest of the electrode stack grown at the stacking location.

In one variant of the apparatus, the control unit is intended and set up for determining a position of a stacked anode/cathode layer in relation to the other layers of the electrode stack by checking the position/rotation/offset of the individual anode/cathode layers in relation to one another after the anode/cathode layers have been placed on the electrode stack, and/or wherein the control unit is intended and set up for determining an offset of the individual anode/cathode layers relative to one another with an image capture of at least one third camera from at least one (vertical and/or transverse) edge of the electrode stack. In a variant of the apparatus, the control unit is intended and set up for checking an obtained image by corner/edge search to determine whether one or more of the anode/cathode layers of the electrode stack protrude inwardly or outwardly relative to the other anode/cathode layers, and/or whether an accuracy was maintained when stacking the anode/cathode layers.

In one variant of the apparatus, the control unit is intended and set up for determining different dimensions with a (vertical) edge stepped in the z-direction in the side view from the image feed in alternating stacked anode layers and cathode layers of the electrode stack, and to examine the shape and/or dimensions of the stacked anode layers and cathode layers. In one variant of the apparatus, the control unit is intended and set up for examining the anode layers and cathode layers stacked on top of one another to determine the deviation from the other anode or cathode layers of the electrode stack with which each individual layer protrudes inwardly or outwardly. In one variant of the apparatus, the control unit is intended and set up for examining an image indentation to determine the deviation in the z-direction (vertical axis) with which the various anode/cathode layers form steps in the electrode stack.

In one variant of the apparatus, the control unit is intended and set up for receiving image captures from at least two third cameras, which contain diagonally opposite corners and/or their edges in the vertical axis (z-axis) of the electrode stack ES at the deposit location, as seen from the side, in order to examine, on the anode layers and cathode layers stacked on top of one another, with what deviation in the x or y direction (transverse, longitudinal) the various anode layers and cathode layers of the electrode stack are above/below each other in the longitudinal and/or transverse direction of the layers; and/or to examine with what deviation in the z direction (vertical axis) the various anode layers and cathode layers of the electrode stack are above/below each other in the longitudinal and/or transverse direction of the layers. layers of the electrode stack; and/or to investigate the deviation in the z-direction (vertical axis) with which the various anode/cathode layers form steps in the electrode stack.

In one variant of the apparatus, the at least two third cameras are aligned with a (high) edge of the electrode stack and/or (white) spotlights are used to illuminate the respective edge of the electrode stack to illuminate the desired position on the electrode stack.

In one variant of the apparatus, the control unit is intended and set up for receiving image feeds from at least four third cameras, which contain the four corners of the electrode stack at the deposit location as seen from above, in order to determine a position of the upper stacked anode/cathode layer in relation to at least one underlying gen layer of the electrode stack by checking the position/rotation/offset of the individual anode/cathode layers relative to one another by means of an image feed from each of the four cameras after the anode/cathode layers have been deposited on the electrode stack.

In one variant of the apparatus, the control unit is intended and set up for taking into account the movements of the lifting apparatus with the respective workpiece carrier along the vertical axis (z-axis) and their inaccuracies by detecting the x-, y-positions of the work piece carrier at different z-heights with the third cameras by means of image feeds before the start of depositing the anode/cathode layers to form the electrode stack, storing the corresponding data in a data memory for comparison with x-, y-positions of the workpiece carrier at different z-heights during the depositing of the anode/cathode layers in order to check whether the anode/cathode den layers have been stacked within the accuracy at the x-, y-position, which corresponds to the z-position of the workpiece carrier on the lifting apparatus, and/or for correcting the orientation in the direction of rotation around the z-axis (vertical axis) (in theta) when picking up the anode/cathode layers with the stacking apparatus.

The procedures and apparatuses described above allow a significant reduction in the risk of short circuits in the module thus formed, which also leads to an increase in the overall quality and efficiency of the fuel or battery cell.

Overall, the apparatus and method described above allows an accuracy of ±0.1 mm or more with a high stack throughput.

Method aspects are shown above in apparatus terms and vice versa. Both the method aspects and the apparatus aspects serve to explain the arrangement and its operation.

### BRIEF DESCRIPTION OF THE DRAWINGS

Further features, properties and advantages of the apparatuses and the methods can be found in the following description in conjunction with the drawing. Possible variations will become clear to a person skilled in the art from the following description, in which reference is made to the accompanying drawings. The figures show schematically the apparatuses discussed here and explain their operation. They show:

FIG. 1 A schematic top view of an assembly line with inspection during the production of modules or preliminary stages of modules;

FIG. 1a A second camera arrangement for inspecting the layers before they are picked up by the stacking apparatus;

FIG. 2 is a schematic side view of a process station of the assembly line from FIG. 1 designed as a stacking unit;

FIG. 2a A first variant of a second camera arrangement for inspecting the layers during transportation from the pick-up location to the stacking location by means of the stacking apparatus;

FIG. 2b A second variant of a second camera arrangement for inspecting the layers during transportation from the pick-up location to the stacking location by means of the stacking apparatus;

FIG. 3 A variant of a third camera arrangement in a side view for inspecting the layers of a stack of electrodes after they have been stacked at the stacking location by means of the stacking apparatus; and

FIG. 3a is a plan view of the variant of the third camera arrangement from FIG. 3.

### DETAILED DESCRIPTION OF THE EMBODIMENTS

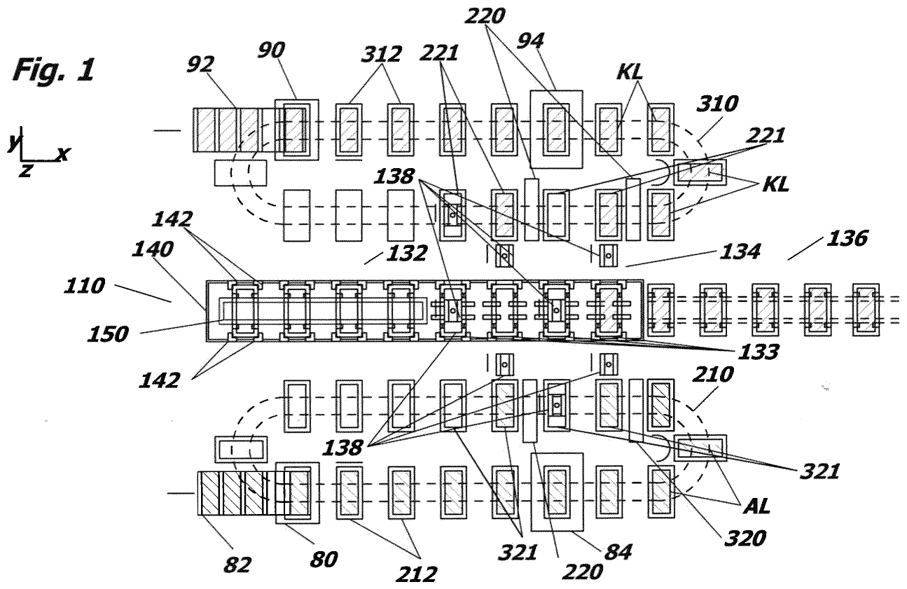

FIG. 1 schematically illustrates a part of an assembly line 100 for the manufacture of modules or preliminary stages of modules. Here, the assembly line 100 is explained by way of example using the manufacture of fuel or battery cells containing layer material and/or fluid. A central transport section 110 conveys a plurality of workpiece carriers 120 between several process stations. The central transport section 110 is set up by means of drives, which are not shown further, to convey the workpiece carriers 120 in groups in individual transport sections.

As supply stations to the assembly line 100, a first cutting or punching station, not shown further, is set up for cutting a first endless layer material coming from a roll into uniform rectangular pieces and, as a sequence of isolated anode layers AL, to deliver it onto a carrier 82. A second cutting or punching station, not shown further, is set up for cutting a second continuous layer material coming from a roll into uniform rectangular pieces and to deliver it onto a carrier 92 as a sequence of separated cathode layers KL. A first depositing station 80 feeds the separated anode layers AL onto transportable adhesive trays 212 of a first transport section 210 in order to feed them to a stacking unit 138. A second depositing station 90 feeds the combined cathode layers KL onto transportable adhesive trays 312 of a second transport port route 310 in order to feed them to a stacking unit 138. On their transport to the stacking unit 130, the anode and cathode layers AL, KL are guided through an inspection station 84, 94 assigned to the respective transport line 210, 310 in order to check their quality. In one variant, the cathode is a metal foil with a conductive coating on both sides and a protruding conductor tab. In one variant, the anode is a metal foil with a conductive coating on both sides, which is laminated between two dielectric foils (separators), with the current conductor tab protruding laterally, i.e. on one of the short sides between the separators.

Instead of the transportable adhesive trays 212 of the first transport section 210 and the transportable adhesive trays 312 of the second transport section 310, a vacuum conveyor belt is provided in one variant. In this variant, too, the first and second transport sections 210, 310 have several pick-up locations 221, 321. Here, too, single-variety handling of the sensitive electrodes is provided, which avoids contamination cleaning of the electrode coatings.

Such an assembly line 100 has a first transport section 116 with the pick-up region 132, the stacking region 134 and the delivery region 136. Several, for example four, first lifting apparatuses 135 are provided in the stacking region 134 in order to lift workpiece carriers 120 off the carriage 140 in the Z direction. The carriage 140 can be positioned in and against the outward path 112 along a first transport section 116. The slide 140 is set up for positioning several empty workpiece carriers 120 in groups from the pick-up region 132 into the stacking region 134 and/or several workpiece carriers, each carrying a stack created in the stacking region 134, from the stacking region 134 into the delivery region 136. Each lifting apparatus 135 is set up for raising and lowering the respective workpiece carrier 120 for stacking by the carriage 140 in a controlled manner. In the conveying direction (x-direction) of the workpiece carriers 120, the carriage 140 has a length that at least approximately corresponds to the extension of the near me region 132 and the stacking region 134, or the stacking region 134 and the discharge region 136 in the conveying direction of the work piece carriers 120. The carriage 140 is arranged to move longitudinally on two linear guides over he and has 2×N holders 142 on each longitudinal side for N workpiece carriers 120 to be positioned. The lifting apparatuses 135 extend between the linear guides and can thus lift the N workpiece carriers 120 at their respective x, y position remaining in the z direction, while the carriage 140 is moved along the linear guides (in the x direction). Similarly, the lifting apparatus 150 is provided in the pick-up region 132 for the N workpiece carriers 120 and a lifting apparatus is provided in the delivery region 136 in each case.

In the receiving region 132, several workpiece carriers 120—here as a group of four—can be removed from the central transport section 110 in the variant shown here. In other variants, more or fewer than four workpiece carriers 120 can also be removed from the central transport section 110. For this purpose, the central transport section 110 has a lifting apparatus 150 on the upstream side of the stacking unit 130 in the receiving region 132, which in one variant can be part of the central transport section 110, here in the form of a scissor lift table. The lifting apparatus 150 is designed to lift a group of four workpiece carriers 120 from the central transport section 110 in the receiving region 132 and place them on a carriage 140. In one variant, the carriage 140 can also be a part of the central transport section 110. This carriage 140 in the stacking unit 130 is to be moved in and against the conveying direction x of the workpiece carriers 120 in a controlled manner by means of a drive, which is not illustrated further, in order to pick up the group of workpiece carriers 120 in the pick-up region 132, to convey it from the pick-up region 132 into a stacking region 134, and from the stacking region 134 into a delivery region 136.

In the stacking region 134, individual anode layers AL and individual cathode layers KL are transported into the stacking region 134 by a number of stacking apparatuses 138 (here four) corresponding to the number of workpiece carriers 120 in the group from a respective first and second transport section 210, 310 located on both longitudinal sides of the central transport section 110 using vacuum or adhesive trays 212, 312, also referred to as shuttles (see also FIG. 1). In other words, two stacking apparatuses 138 are assigned to each workpiece carrier 120 in the stacking region 134. For this purpose, the arrangement of the stacking apparatuses 138 is equipped with respective drives, which are not further illustrated, in order to move the stacking apparatuses 138 individually vertically in the z-direction for raising and lowering the individual anode and cathode layers KL. In the variant shown here, the transport sections 210, 310 are each endless transport sections and are set up for conveying the vacuum or adhesive trays 212, 312 in a horizontal conveying plane along a closed path.

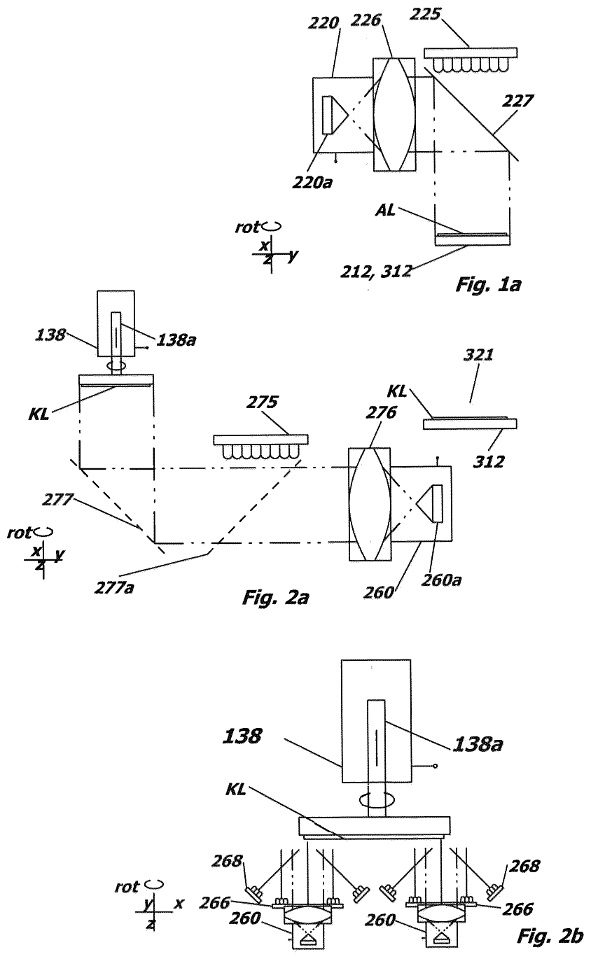

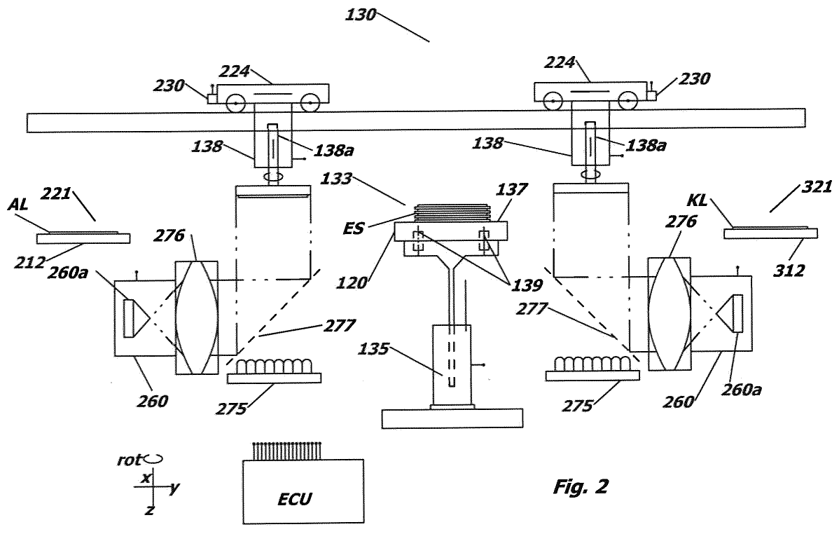

Further drives 224 illustrated below in connection with FIG. 2 serve to move the stacking apparatuses 138 individually horizontally in the y-direction, transversely to the central transport section 110, in order to transport the individual anode and cathode layers AL, KL from the trays of the first and second transport sections 210, 310 to the respective stacking location 133 on the workpiece carrier 120 in the stacking region 134. In the process, individual anode layers AL from a first side of the workpiece carrier 120 and individual cathode layers KL from a second side of the workpiece carrier 120 are alternately brought to the respective workpiece carrier 120 and stacked on the respective workpiece carrier 120 to form an electrode stack ES. The assembly line 100/the stacking unit 130 according to FIG. 1 comprises, by way of example, 4 stacking lines 133. The stacking unit 130 also has several first lifting apparatuses 135 acting in the z-direction, one per workpiece carrier 120, in order to lift the workpiece carriers 120 from the carriage 140 in the z-direction in a controlled manner and thus separate them from the carriage 140, and to place these workpiece carrier(s) 120 on the carriage 140 in the z-direction in a controlled manner. This allows the workpiece carriers 120 to be loaded with the layer material to form the stack of electrodes ES, while the carriage 140 can be moved back and forth in the x-direction.

At each stacking location 133, a flat holder 137 with positioning pin 139 is provided, which receives an empty workpiece carrier 120 and holds it in the exact position (see FIG. 2).

In FIG. 2, a workpiece carrier 120 located in the stacking unit 130 on one of the first lifting apparatuses 135 is shown, which is lifted out of the carriage 140 not shown and is located at a stacking location 133. At this stacking location 133, the empty workpiece carrier 120 is filled as described below, and then returned to the central transport section 110 for conveying to a subsequent process station. As described above, the first lifting apparatus 135 serves to remove the at least one empty work piece carrier 120 from the central transport section 110. At each stacking location 133, a stacking apparatus 138 transports the individual anode layers AL (left in FIG. 2) and a stacking apparatus 138 transports the individual cathode layers KL (right in FIG. 2) alternately from both sides of the workpiece carrier 120 in and against the y-direction and stacks them on the workpiece carrier 120 in the z-direction. In this way, the electrode stack ES grows to the desired number of layers. In one variant, the workpiece carrier 120 is lowered after each anode layer AL or cathode layer in the z-direction by the height/thickness of an anode layer AL or cathode layer.

Each of the stacking apparatuses 138 is intended and set up for picking up either the individual anode layers AL/the individual cathode layers KL by means of controlled pneumatic negative pressure and to hold them above the workpiece carrier 120 during transportation to the stacking location 133. Each stacking apparatus 138 has a flat gripping tool which is to be subjected to negative pressure for holding and transporting an anode/cathode layer AL, KL. In one variant, it is also provided to release the individual anode layers AL and the individual cathode layers KL at the stacking location 133 by means of a short controlled pneumatic overpressure shock in order to stack the layers AL, KL on the workpiece carrier 120.

In addition to conveying the layers AL, KL, the apparatus described here also serves to inspect the layers AL, KL on their way from their respective transport sections 210, 310 to the corresponding stacking station 133. For this purpose, the pick-up stations 221, 321 are provided in the stacking region 134, to which the separated anode/cathode layers AL, KL are transported with the vacuum or adhesive trays 212, 312. Before the adhesive trays 212, 312 with the anode/cathode layers arrive at the corresponding stacking location 133, the anode/cathode layers AL, KL are captured by a second camera 220. This second camera 220 is used to detect the position and/or orientation, here in x, y and theta, of the anode/cathode layer on its adhesive tray 212, 312 before the anode/cathode layers AL, KL are picked up from their adhesive tray 212, 312 by the stacking apparatus 138. An inspection of an anode layer AL or a cathode layer KL with the second camera 220 can be carried out while the vacuum or adhesive tray 212, 312 transporting the anode/cathode layer AL, KL to be inspected is moved along the closed path of the transport section 210, 310.

Alternatively, an inspection of an anode layer AL or a cathode layer KL can be carried out cathode layer KL can be carried out with the second camera 220 while the vacuum or adhesive tray 212, 312 transporting the anode/cathode layer AL, KL to be inspected is stationary (for a short time, a few milliseconds) and other vacuum or adhesive trays 212, 312 moving along the closed path of the transport section 210, 310, for example a vacuum or adhesive tray 212, 312 moving directly along the closed path before and/or after the vacuum or adhesive tray 212, 312 (briefly) stationary for inspection with the second camera 220, are moved along the closed path of the transport section 210, 310.

The second camera 220 is aligned in such a way that it can capture an image feed in a vertical plan view of the anode/cathode layer during transport of its position and/or orientation (in x, y, and/or theta) shortly before the respective anode/cathode layer AL, KL arrives at its pick-up location 221, 321. In FIG. 2, two of the first cameras 220 for the anode layers AL and two for the cathode layers KL are view shown. It should be understood that a second camera 220 can also be provided in front of each recording location 221, 321, or only in front of the respective first recording location 221, 321. A white light source 225 is provided for each first camera 220 (see FIG. 1a) in order to illuminate the anode/cathode position for the image capture by the camera 220. From depending on the spatial conditions, the second camera 220—as also illustrated in FIG. 1a—is designed as a full-frame camera to completely capture the anode/cathode position AL, KL with a single image capture, or the second camera is designed as a line scan camera to capture the position and/or orientation of the anode/cathode position in x, y, and/or theta while it is transported to the corresponding recording location 221, 321. The full frame camera may, for example, have a digital image capture chip 220a with 24 megapixels. Depending on the requirements for accuracy and resolution and the spatial conditions, the second camera 220 can also—with appropriate optics, for example a lens 226 and a 90° deflecting mirror 227 that is semi-transparent for the white light—provide a full image capture from above onto the anode/cathode position.

Each stacking apparatus 138 is assigned a conveying apparatus 224 for conveying the stacking apparatus 138 back and forth between the respective pick-up location 221, 321 and the stacking location 133. Thus, with a number of stacking apparatuses 138 (here four) corresponding to the number of workpiece carriers 120 in the group, individual anode layers AL and individual cathode layers KL are transported into the stacking region 134 from a respective first and second transport section 210, 310 located on both longitudinal sides of the central transport section 110 with vacuum or adhesive trays 212, 312, also referred to as shuttles (see also FIG. 1). In other words, two stacking apparatuses 138 are assigned to each workpiece carrier 120 in the stacking region 134. For this purpose, the arrangement of the stacking apparatuses 138 is equipped with respective actuators 138a in order to move the stacking apparatuses 138 individually vertically in the z-direction for raising and lowering the individual anode AL and cathode layers KL. Further drives 224 are used to move the stacking apparatuses 138 individually horizontally in the y-direction, transverse to the central transport section 110, in order we to transport the individual anode and cathode layers AL, KL from the trays 211, 311 of the first and second transport sections 210, 310 to the respective stacking location 133.

In each case, a common horizontal linear guide is provided for two stacking apparatuses 138 and arranged above a respective workpiece carrier positioned in the stacking region 134. The linear guide extends from a pick-up location of the transport section 210 to a pick-up location of the transport section 310 and spans the stack region 134.

Sensors 230 serve as a detection apparatus for detecting the position and/or orientation (in x, y, z, and/or theta) of the stacking apparatus 138. These sensors 230, of which only the position of the stacking apparatus 138 y-direction is illustrated here for the sake of clarity, supply corresponding data to a control unit ECU.

On the path from the pick-up location 221, 321 to the stacking location 133, each stacking apparatus 138 passes a first camera 260. This first camera 260 is used to detect the position and/or orientation (in x, y, z, and/or theta) of the anode/cathode layer AL, KL on the underside of the stacking apparatus 138 relative to the position and/or orientation (in x, y, z, and/or theta) of the stacking apparatus 138 on its path to the stacking location 133. This data is fed to the control unit ECU and processed there in order to control the corresponding actuating apparatuses, for example the actuators 138a, 224, etc. These positioning apparatuses also include pneumatic actuators not illustrated further so that the stacking apparatus 138 can pick up and place the anode/cathode layers AL, KL, electric or pneumatic actuators to align the stacking apparatus 138 in x, y, z, and/or the ta, during the transport of the anode/cathode layer to the stack location 133, so that the anode/cathode layer AL, KL is optimally positioned for stacking relative to the stack location 133 and the stack of electrodes located there, and for stacking the anode/cathode layer at the stacking location 133.

The first camera 260 is used here to detect the position and/or orientation (in x, y, z, and/or theta) of the anode/cathode layer AL, KL relative to the stacking apparatus 138 before the anode/cathode layer AL, KL is stacked at the stacking location 133. This data is fed to the control unit ECU and processed there. The control unit ECU determines correction values from the image feed and the data from the various detection apparatuses. In particular, the position and/or orientation (in x, y, z, and/or theta) of the anode/cathode position AL, KL at the pick-up location or on the way to it prior to pick-up by a stacking apparatus 138, the position and/or orientation (in x, y, z, and/or theta) of the stacking apparatus 138 at the pick-up location or on the path thereto, as well as the position and/or orientation (in x, y, z, and/or theta) of the individual anode/cathode layer taken on relative to the stacking apparatus 138 during transportation tie of the anode/cathode layer to the stacking location 133, the correction values are determined. These correction values are used to align the stacking apparatus 138 with the transported anode/cathode layer relative to the stacking location 133 in x, y, z, and/or theta, so that the transported anode/cathode layer is deposited precisely at its target position relative to the electrode stack ES located at the stacking location 133. In other words, these correction values are taken into account when correcting the orientation and location (in x, y, z, and/or theta) of the stacking apparatus 138 when picking up the anode/cathode layer in positioning to the positioning apparatus, the conveyor 224 and/or the stacking apparatus 138 in such a way that the anode/cathode layer is picked up nom by the stacking apparatus 138, for example in a central zero position or in alignment with the stack of electrodes located at the stacking location 133.

The first camera 260 is aligned such that during the transport of the anode/cathode layer, its position and/or orientation (in x, y, and/or theta) is captured in a vertical right view from below with an image feed, shortly before the respective anode/cathode layer AL, KL arrives at its stacking location 133. FIG. 2 illustrates one of the second cameras 260 for the anode layers AL and one of the second cameras 260 for the cathode layers KL. In each second camera 260, a light source 275, for example a white light source, is provided to illuminate the anode/cathode layer for the image capture by the first camera 260. Depending on the spatial conditions, the second camera 220—as also illustrated in FIG. 1a—is designed as a full-frame camera from in order to completely capture the anode/cathode position AL, KL with a single image feed, or the first camera ra 260 is designed as a line scan camera in order to capture the position and/or orientation in x, y, and/or theta of the anode/cathode position while it is being transported to the corresponding stack location 133. The full frame camera can, for example, have a digital image capturing chip 260a with 24 megapixels. Depending on the requirements for accuracy and resolution and spatial conditions, the first camera 260 can also—with the appropriate optics, for example a lens 276 and a 90° deflection mirror 277 that is half transparent for the white light—provide a full image feed from below onto the anode/cathode position. The light source 275 can also be pivotably arranged at in order to provide an optimum incidence of light on the respective anode/cathode position AL, KL. For example, the first camera 260 can provide a field of view of the anode/cathode position AL, KL of at least 720×400 mm at a resolution of 134 μm/pixel or higher.

A ring light source is arranged in the beam path of the second camera 260, i.e. in the region of the vertical section of the beam path. Light (approx. 600-780 nm) from the ring light source strikes the underside of the anode or cathode at a flat angle, i.e. less than 45 degrees, to enhance the contrast of surface defects.

FIG. 2a shows a variant of an arrangement of the second camera 260. Here, the first camera 260 is also aligned in such a way that during the transport of the anode/cathode layer, its position and/or orientation (in x, y, and/or theta) is detected in a vertical right view from below with an image feed, shortly before the respective anode/cathode layer AL, KL arrives at its stacking location 133.

In contrast to the arrangement in FIG. 2, the white light source 275 is shown here between the horizontal right section of the optical path of the camera 260 and the stacking apparatus 138. For this purpose, a further semi-transparent 90° deflection mirror 277a is provided between the camera 260 and the semi-transparent 90° deflection mirror 277 in order to direct the white light into the beam path onto the underside of the stacking apparatus 138 with the anode/cathode position for image capture by the first camera 260. Otherwise, the arrangement of the camera in FIG. 2a corresponds to that in FIG. 2.

Instead of a full image capture by means of a single camera, only selected regions, in this case corner/edge regions of the anode/cathode layer AL, KL can be captured during their transport with regard to their position and/or orientation (in x, y, and/or theta) in a vertical view from un ten shortly before the respective anode/cathode layer AL, KL arrives at its stacking position 133. For this purpose, as shown in FIG. 2b, two second cameras 260 are used to capture the corner regions of the anode/cathode layer AL, KL vertically from below when the anode/cathode layer AL, KL is transported over them. In particular, one image of the layer KL adhering to the stacking apparatus 138 by means of negative pressure is captured at each corner during transport (“on the fly”), i.e. while the anode/cathode layer Al, KL held on the stacking apparatus is continuously moved to the stacking location 133.

In front of each stacking location be there are (on one side) one or two cameras 260 for the anode position AL and (on the other side) one or two cameras 260 for the cathode position KL. For the sake of clarity, only one camera 260 is shown in each of the Figs. While the anode/cathode layers Al, KL held on the stacking apparatus move past the cameras 260, first an image of a corner at the front edge of the layer AL or KL is taken, or first two images of the corners at the front edge of the layer AL or KL are taken. Subsequently, an image of a (preferably diagonal) corner at the rear edge of the layer AL or KL is first taken, or the other two corners at the rear edge of the layer AL or KL are taken with the two cameras 260. From any deviations between the positions of the corners at the front edge and the corners at the rear edge transverse to the transport rich direction of the respective layer AL or KL, the control unit ECU determines correction values. KL, the control unit ECU determines correction values (in x, y, and/or theta) for the movement and orientation of the stacking apparatus 138 relative to the location/corners of the electrode stack ES, so that the anode/cathode den position AL, KL can be placed vertically on the electrode stack ES very quickly when the stack reaches the stack location 133 with minimal (ideally no) further correction requirements.

In the stacking apparatuses 138, in one variant, the holding surface of the gripping tool for picking up and holding an anode/cathode layer AL, KL can be smaller than the surface of an anode/cathode layer AL, KL. For example, the (four) corner regions of the gripping tool can be recessed. Consequently, an anode/cathode layer AL, KL can be illuminated during transportation in the corner regions from above, i.e. from the side with the light source 275, which is in contact with the gripping tool. As a result, edges of the cathode layer KL can be detected with particularly high contrast compared to the surroundings.

In FIG. 2b, the arrangement of each of the first cameras comprises a matrix camera 260 with a red coaxial ring illumination 266 and/or a blue dark-field illumination 268. The dark-field illumination provides flat (here at an angle of 45° to the optical axis) irradiated light, so that, for example, the edges regions reflect or scatter light towards the camera and then appear clearly contrasted and bright in the camera image.

With such an arrangement, it is possible to capture a square region of approx. 21×21 mm at a resolution of 10.8 μm/pixel or better.

Due to the presence of several adjacent stacking units 130, the inspection of the anode/cathode layers AL, KL can be parallelized.

It may be provided that a plurality of anodes for a first group of not immediately adjacent electrode stacks or workpiece carriers 120 in the stacking region 134, e.g. the first workpiece carrier and the third workpiece carrier, are inspected overlapping in time with the respective second camera 260 and/or a plurality of cathodes for a second, different from the first, group of not immediately adjacent electrode stacks or workpiece carriers 120 in the stacking region, e.g. workpiece carriers 2 and 4, are inspected overlapping in time with the respective second camera 260.

Since directly adjacent stacking apparatuses 138 move towards each other, i.e. perform opposing movements in the Y direction, oscillations/vibrations can be compensated and efficient inspection can be achieved. In addition, the separate stacking apparatuses 138 allow the anodes to be handled independently of the cathodes. This prevents the sensitive electrodes from alternately contacting the same surfaces. This avoids contamination of the electrode coatings.

Alternatively, it may be provided that the anode layers and the cathode layers are provided in groups at the plurality of pick-up locations of the respective transport section 210, 310 by the vacuum or adhesive tray 212, 312.

In another variant, the camera 260 inspects the anode and cathode layers in groups. In a variant not shown, for example, a different resolution and a different field of view can be obtained, whereby four cameras 260 can also be set in order to inspect all four corners at the same time, or a line scan camera.

All of the inspection variants described above are used to determine the exact position of the anode/cathode layer AL, KL at least once in order to then correct the alignment prior to removal. By optically detecting the position and orientation of characteristic regions (corners, edges) of the layers AL, KL in the pick-up location and/or during transport to the stacking location 133, and using the data thus obtained won to correct the orientation of the stacking apparatus 138 relative to the electrode stack ES at the stacking location 133 before and/or during transport of the layers AL, KL to the stacking location 133, this depositing is possible in a time-efficient manner and with high precision.

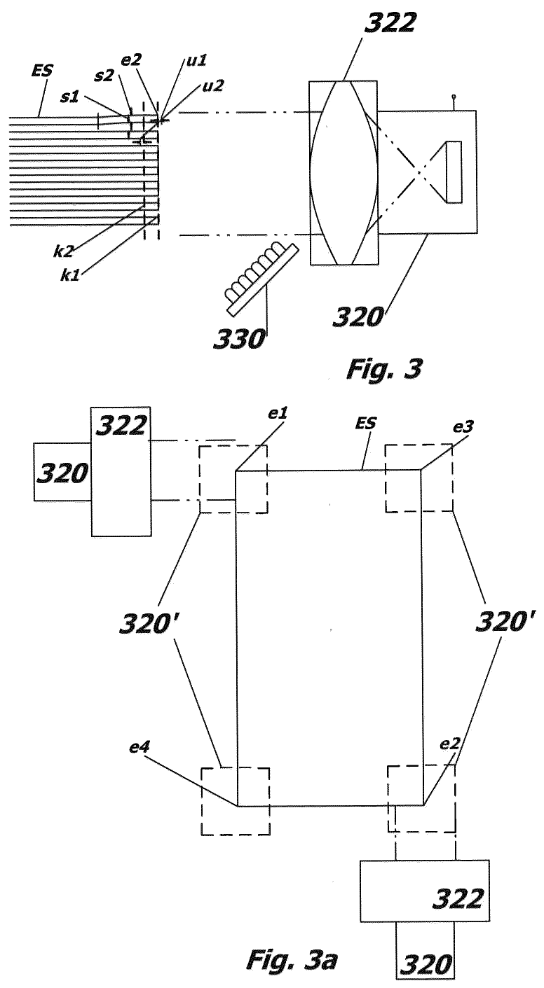

With reference to FIGS. 2 and 3, a further inspection method to be used in the manufacture of modules or preliminary stages of modules is explained below. In a first step, a separated anode/cathode layer AL, KL is provided on a respective vacuum or adhesive tray 212, 312. Subsequently, the separated anode/cathode layer AL, KL is transported by a stacking apparatus 138 to a stacking location 133. There, the transported anode/cathode layer AL, KL is stacked. At the stacking location 133, a detection of an electrode stack ES grown around the stacked anode/cathode layer AL, KL at the stacking location 133 takes place in at least one side view and/or including a high edge of the electrode stack ES. In a variant of the method, this detection of the side view or a high edge of the electrode stack ES provides an image indent. Finally, the alignment direction and/or the position of the or each stacked anode/cathode layer AL, KL relative to the rest of the electrode stack grown at the stacking location is checked.

A position of a stacked anode/cathode layer AL, KL in relation to the other layers of the electrode stack ES is determined, for example, by checking the position/displacement/offset of the individual anode/cathode layers AL, KL relative to one another after the anode/cathode layers AL, KL have been placed on the electrode stack ES. An offset of the individual anode/cathode layers (AL, KL) relative to one another can be determined, for example, by means of an image capture by at least a third camera 320 of at least one (vertical and/or transverse) edge of the electrode stack ES. For example, a resulting image capture can be checked using computer-aided image processing methods by corner/edge search to determine whether one or more of the anode/cathode layers AL, KL of the electrode stack ES protrude laterally or longitudinally above or below the other anode/cathode layers AL, KL, and/or whether a predetermined accuracy was maintained when stacking the anode/cathode layers AL, KL. A variant of the edge search uses a Canny algorithm (Canny edge detector), which provides an image that ideally only contains the edges of the original image.

Alternately stacked anode layers AL and cathode layers KL of the electrode stack ES generally have different dimensions. This leads to a stepped (raised) edge in the z-direction in the side view during stacking. This high edge or the two high edges k1, k2, see FIG. 3, are examined using the captured image indents. At the stacked anode layers AL and cathode layers KL are examined for their shape and/or dimensions. In other variants, the stacked anode layers AL and cathode layers KL are examined to determine the difference between the anode and cathode layers AL, KL and the rest of the anode and cathode layers stacked on top of each other and the extent to which each individual layer protrudes or protrudes laterally or in the longitudinal direction. A rotation around the vertical axis (in theta) can also be determined from these overhangs/underhangs (u1, u2 in FIG. 3), or the deviation in the z direction (vertical axis) with which the various de anode/cathode layers (AL, KL) form steps (s1, s2 in FIG. 3) in the electrode stack.

FIGS. 3, 3a illustrate how two third cameras 320 are directed from the side onto diagonally opposite corners e1, e2 and/or their edges k1, k2 (see FIG. 3) in the vertical axis (z-axis) of the electrode stack ES at the stacking location. In this way, the deviation u1, u2 of the anode layers AL and cathode layers KL stacked on top of each other (see FIG. 3) in the x or y direction (transverse, longitudinal) with respect to the other anode or cathode layers AL, KL of the electrode stack ES with which each individual layer protrudes outwardly/inwardly in the longitudinal and/or transverse direction of the layers is determined. This means that a deviation s1, s2 of the steps (see FIG. 3) in the z-direction (vertical axis) by the anode/cathode layers AL, KL lying on top of each other in the electrode stack can be examined.

In this case, the two third cameras 320 are aligned directly to a high edge of the electrode stack. Furthermore, a white spotlight 330 can be used to illuminate the respective edge of the electrode stack ES in order to illuminate the desired target position at an angle of approximately 45° to the optical axis of the respective third camera 320.

In a variant shown as a dashed line in FIG. 3a, four third cameras 320′ are directed vertically from above, with spotlights 330 not shown further, onto the four corners e1, e2, e3, e4 of the electrode stack at the deposit point as seen from above. This allows a position of the uppermost stacked anode/cathode layer AL, KL to be determined in relation to at least one underlying layer of the electrode stack ES. The position/rotation/offset of the individual anode/cathode layers AL, KL relative to one another is checked by means of an image capture from each of the four cameras 320′ after the anode/cathode layers AL, KL have been placed on the electrode stack ES.

With the cameras 320 (see FIG. 3) directed laterally onto the high edge of the electrode stack ES, movements of the lifting apparatus 135 with the respective workpiece carrier 120 along the high axis (z-axis) can be determined by corresponding processing of the image indents. Before starting to deposit the anode/cathode layers AL, KL to form the electrode stack ES, the x, y positions of the workpiece carrier at different z heights are thus detected with the third camera 320 from image indents obtained in the process. The resulting data is stored for comparison with x, y positions of the workpiece carrier at different z heights during deposition of the anode/cathode layers in order to check whether the anode/cathode layers have been stacked within a predetermined accuracy at the x, y position corresponding to the respective z position of the work piece carrier on the lifting apparatus 135. In one variant, the data obtained above is used to correct the orientation in the direction of rotation about the z-axis (vertical axis) (in theta) when picking up the anode/cathode layers with the stacking apparatus 138.

From the processed data of the image captures from the cameras, in particular at least one of the third cameras, it is also provided in one variant to use the stacking apparatus 138 to pick up an incorrectly deposited layer from the electrode stack ES again and optionally to deposit it correctly on the electrode stack again, or to transport it to a position at which it is discarded.

The variants of the apparatus described above, their structural and operational aspects as well as the variants of the method are merely intended to provide a better understanding of the structure, the mode of operation and the properties; they do not limit the disclosure of the embodiments. The figures are partly schematic. Essential properties and effects are shown, in some cases clearly enlarged, in order to clarify the functions, operating principles, technical designs and features. Each mode of operation, each principle, each technical embodiment and each feature disclosed in the Fig. or in the text can be freely and arbitrarily combined with all claims, each feature times in the text and in the other Fig., other modes of operation, principles, technical embodiments and features contained in this disclosure or resulting therefrom, so that all conceivable combinations can be assigned to the procedure described. This also includes combinations between all individual embodiments in the text, i.e. in each section of the description, in the claims and also combinations between different variants in the text, in the claims and in the figures. Nor do the claims limit the disclosure and thus the possible combinations of all the features disclosed. All disclosed features are also explicitly disclosed here individually and in combination with all other features.

1. An inspection method in the manufacture of modules or precursors of modules, said method comprising:
providing a separated anode/cathode layer at a pick-up location;
conveying a stacking apparatus to the pick-up location;
picking up the anode/cathode layer from the pick-up location by the stacking apparatus;
detecting the position and/or orientation of the picked up individual anode/cathode layer;
transporting the picked up individual anode/cathode layer to a stacking location by the stacking apparatus;
aligning the stacking apparatus with the picked up and transported anode/cathode layer relative to the stacking location; and
stacking the picked up and transported anode/cathode layer at the stacking location,
wherein the position and/or orientation of the picked up individual anode/cathode layer is detected during the transportation of the picked up individual anode/cathode layer by the stacking apparatus to the stacking location by a first camera,
wherein correction values are determined from the position and/or orientation of the picked up individual anode/cathode layer during a transportation of the picked up individual anode/cathode layer to the stacking location, and
wherein the correction values are taken into account when aligning the stacking apparatus with the picked-up and transported anode/cathode layer relative to the stacking location.

2. The inspection method according to claim 1, wherein alternately
a first stacking apparatus is used to transport individual anode layers from a first side to the stacking location, and
a second stacking apparatus is used to transport individual cathode layers from an opposite second side to the stacking location; and/or alternately
individual anode layers are transported to the stacking location exclusively from the first side by a first stacking apparatus, and
individual cathode layers are transported to the stacking location exclusively from the opposite second side by a second stacking apparatus.

3. The inspection method according to claim 2, wherein the detection of position and/or orientation of the anode/cathode layer takes place
before the anode/cathode layer is picked up by the stacking apparatus from the pick-up location, and/or wherein
the position and/or orientation of the anode/cathode layer is detected
before the anode/cathode layer is picked up by the stacking apparatus from the pick-up location by a second camera.

4. The inspection method according to claim 2, wherein:
the first and/or the second camera detect the position and/or orientation of the anode/cathode layer in a vertical, ±about 25°, top view of the anode/cathode layer; and/or
a light source associated with the first and/or the second camera illuminates the anode/cathode layer for an image feed by the first and/or the second camera; and/or
the first and/or the second camera with a single image capture capture a position and/or orientation of the anode/cathode layer; and/or
the first and/or the second camera with a single image capture
a region,
at least one corner region,
two diagonal corner regions, and/or
at least one corner region and at least a portion of an edge of the anode/cathode layer in order to detect the position and/or orientation of the anode/cathode layer; and/or
the first and/or the second camera are configured as a line scan camera which detects the position and/or orientation of the anode/cathode layer before the anode/cathode layer is picked up by the stacking apparatus or on arrival at the pick-up location or on the way to the pick-up location.

5. The inspection method according to claim 3, wherein:
at least one optically effective element is connected upstream of the first and/or the second camera in order to detect the position and/or orientation of the anode/cathode layer at one or more locations or regions before the anode/cathode layer is picked up by the stacking apparatus or when the anode/cathode layer arrives at the pick-up location or on the way to the pick-up location.

6. The inspection method according to claim 1, wherein:
correction values from
the position and/or orientation of the anode/cathode layer before the anode/cathode layer is picked up by the stacking apparatus,
the position and/or orientation of the stacking apparatus, and/or
the position and/or orientation of the picked-up individual anode/cathode layer during transportation of the anode/cathode layer to the stacking location, are determined; and
the correction values are taken into account when aligning the stacking apparatus with the transported anode/cathode layer relative to the stacking location; and/or
the correction values are taken into account when aligning the stacking apparatus for picking up the anode/cathode layer by the stacking apparatus in such a way that the anode/cathode layer is picked up by the stacking apparatus in a central zero position and/or aligned.

7. The inspection method according to claim 1, wherein:
a plurality of separated anode or cathode layers corresponding to a number of stacking units in the stacking region are provided in groups at the respective pick-up locations.

8. An apparatus for conveying and inspecting modules or precursors of modules, said apparatus comprising:
a stacking apparatus set up for picking up a separated anode/cathode layer at a pick-up location;
a conveyor set up for conveying the stacking apparatus towards and away from the pick-up location;
a first camera set up for detecting the position and/or orientation (in x, y, z, and/or theta) of the picked up individual anode/cathode layer on its path from the pick-up location to the stacking location;
an actuating apparatus, comprising at least one actuator, configured for
actuating the stacking apparatus for picking up the anode/cathode layer, and/or for
aligning the stacking apparatus with the picked up individual anode/cathode layer relative to the stacking location during transportation of the picked up anode/cathode layer to the stacking location, and for
stacking the anode/cathode layer at the stacking location, and
wherein an electronic control unit (ECU) is configured to determine correction values from the data from the image capture of the first camera,
wherein the correction values are determined from the position and/or orientation of the picked up individual anode/cathode layer relative to the stacking apparatus during transportation of the picked up individual anode/cathode layer to the stacking location, and
wherein the correction values are taken into account when aligning the stacking apparatus with the picked-up and transported anode/cathode layer relative to the stacking point in positioning commands to a positioning device, the conveyor apparatus and/or the stacking apparatus.

9. The apparatus for conveying and inspecting modules or precursors of modules according to claim 8, wherein
a first stacking apparatus is arranged to transport individual anode layers from a first side, and a second stacking apparatus is arranged to transport individual cathode layers alternately from an opposite second side to the stacking location; and/or wherein
the first stacking apparatus transports individual anode layers exclusively from the first side, and the second stacking apparatus transports individual cathode layers exclusively from the opposite second side.

10. The apparatus for conveying and inspecting modules or preliminary stages of modules according to claim 8, wherein
a first camera is set up for detecting position and/or orientation of the anode/cathode layer during transportation of the anode/cathode layer by the stacking apparatus to the stacking location; and/or
a second camera is set up for detecting the position and/or orientation of the anode/cathode layer before the anode/cathode layer is picked up by the stacking apparatus from the pick-up location.

11. The apparatus for conveying and inspecting modules or preliminary stages of modules according to claim 10, wherein
the first and/or the second camera are set up for detecting the position and/or orientation of the anode/cathode layer in a vertical, ±about 25°, top view of the anode/cathode layer; and/or
a light source associated with the first and/or second camera is set up for illuminating the anode/cathode position for an image capture by the first and/or second camera; and/or
the first and/or the second camera are set up for capturing the anode/cathode layer with a single image feed to detect the position and/or orientation of the anode/cathode layer; and/or
the light source associated with the first and/or second camera is set up for illuminating the anode/cathode layer for an image capture by the first and/or second camera; and/or
the first and/or the second camera are set up for capturing
a region;
at least one corner region,
two diagonal corner regions, and/or
at least one corner region and at least one section of an edge of the anode/cathode layer in order to detect the position and/or orientation of the anode/cathode layer; and/or
the first and/or the second camera are designed as a line scan camera, which are set up for detecting the position and/or orientation of the anode/cathode layer before the anode/cathode layer is picked up by the stacking apparatus or on arrival at the pick-up location or on the way to the pick-up location.

12. The apparatus for conveying and inspecting modules or preliminary stages of modules according to claim 10, wherein
at least one optically active element is connected upstream of the first and/or the second camera and is set up for detecting the position and/or orientation of the anode/cathode layer at one or more locations or regions before the anode/cathode layer is picked up by the stacking apparatus or on arrival at the pick-up location or on the way to the pick-up location.

13. The apparatus for conveying and inspecting modules or preliminary stages of modules according to claim 8, wherein:
the ECU is set up for determining correction values from the data from the acquisition apparatus and/or the image capture of the first and/or the second camera, wherein the correction values can be determined from the position and/or orientation of the anode/cathode layer before the anode/cathode layer is picked up by a stacking apparatus,
the position and/or orientation of the stacking apparatus, and/or
the position and/or orientation of the picked-up individual anode/cathode layer relative to the stacking apparatus during transportation of the anode/cathode layer to the stacking location; and
taking the correction values into account when aligning the stacking apparatus with the transported anode/cathode layer relative to the stacking location in positioning commands to the positioning apparatus, the conveyor apparatus and/or the stacking apparatus; and/or
the correction values take into account the orientation and the location of the stacking apparatus when picking up the anode/cathode layer in positioning commands to the positioning apparatus, the conveying apparatus and/or the stacking apparatus such that the stacking apparatus picks up the respective anode/cathode layer in a centered zero position and/or aligned with the electrode stack located at the stacking location.

14. The apparatus for conveying and inspecting modules or preliminary stages of modules according to claim 8, wherein a transport section is set up for providing anode/cathode layers in groups at a plurality of pick-up locations with respective vacuum or adhesive trays.
